(19) United States
(12) Patent Application Publication
(10) Pub. No.: US 2025/0307053 A1
(43) Pub. Date: Oct. 2, 2025

(54) METHOD AND DEVICE FOR CONTROLLING EMBEDDED SOFTWARE MEMORY ACCESS

(71) Applicant: STMicroelectronics International N.V., Geneva (CH)

(72) Inventors: Yves Janin, Grenoble (FR); Stephane Martin, Gieres (FR); Pierre Gobin, Seyssinet-Pariset (FR)

(21) Appl. No.: 19/091,013

(22) Filed: Mar. 26, 2025

(30) Foreign Application Priority Data
Mar. 27, 2024 (FR) FR2403077

(51) Int. Cl. G06F 11/07; G06F 9/50

(52) U.S. Cl. CPC G06F 11/0778; G06F 9/5016; G06F 11/0772

(57) ABSTRACT

A method for controlling memory access for an embedded computer program, during the development phase, the computer program being executed in a device comprising a memory unit, the memory unit comprising a payload storage space and a corresponding space for storing error detector or corrector codes, the method comprising storing a state indicator in a location of the error code storage space, the stored state indicator being independent of a payload stored in a corresponding location of the payload storage space and being representative of a state of the location of the payload storage space, and detecting a memory access error in a location of the payload storage space depending on a state indicator stored in a corresponding location of the error code storage space.

### CROSS-REFERENCE TO RELATED APPLICATIONS

This application claims the benefit of French Patent Application No. 2403077, filed on Mar. 27, 2024, which application is hereby incorporated herein by reference.

### TECHNICAL FIELD

Embodiments relate to the field of the reliability and security of computer programs or software, in particular embedded software, and particularly the development of embedded software using programming languages that are not very reliable in terms of memory access.

### BACKGROUND

Embedded software development is a process that is often long and costly, particularly in that this software may be difficult to debug.

The programming languages commonly used, such as the C language and the C++ language, are effective and flexible, but they are not reliable as regards memory access, in write and/or read. A lack of memory access reliability poses problems insofar as memory access errors may lead to unrecoverable computer crashes and/or security vulnerabilities.

Solutions solving these problems, making it possible for a developer to control the memory accesses and identify possible errors, consist in adding instructions, for example during the compilation, in a code generation tool, or during disassembling and re-encoding steps, at particular locations of the software, in order to study the behavior of the latter and of its memory accesses.

However, these solutions are often complex to implement and require a particular test environment generally using an improved operating system. Furthermore, these solutions require important resources in terms of computing power and memory.

Therefore, there is a need for a method and a device for controlling memory accesses during the development of embedded software.

### SUMMARY

According to one aspect, a method for controlling the memory access is proposed for an embedded computer program, during the development phase, the computer program being executed in a device comprising at least one memory unit, the at least one memory unit comprising at least one payload storage space and a corresponding space for storing error detector codes or error corrector codes, called error codes.

According to embodiments, the method comprises storing a state indicator in a location of the error code storage space, the stored state indicator being independent from a payload stored in a corresponding location of the payload storage space and being representative of a state of the location of the payload storage space, and detecting a memory access error in a location of the payload storage space depending on a state indicator stored in a corresponding location of the error code storage space.

Such a method makes it possible to facilitate the development of embedded software by simplifying the detection of memory access errors, without substantial modification of the embedded system or additional specific resources and without using an advanced operating system.

According to embodiments, the method comprises a step of initializing the error code storage space the initialization step comprising storing a state indicator in each location of the error code storage space the state indicator stored in each of the locations being representative of a misallocation of a corresponding location of the payload storage space.

Such a method thus makes it possible to identify a location of the payload storage space that has not been allocated and therefore to detect an access error related to such a location.

According to embodiments, the method comprises a step of allocating, to the computer program, at least one portion of the payload storage space, the allocation comprising storing a state indicator in each location of the error code storage space corresponding to the at least one portion of the payload storage space, the state indicator stored in each of the locations of the error code storage space corresponding to the at least one portion of the payload storage space being representative of an allocation of a corresponding location of the payload storage space.

Such a method thus makes it possible to identify a location of the payload storage space that has been allocated, but of which content has not been initialized, and therefore to detect an access error related to such a location.

According to embodiments, the method further comprises a step of deallocating at least one portion of the payload storage space, the deallocation comprising updating a state indicator in each location of the error code storage space corresponding to the at least one portion of the payload storage space to be deallocated, the state indicator updated in each of the locations of the error code storage space corresponding to the at least one portion of the payload storage space to be deallocated being representative of a misallocation of a corresponding location of the payload storage space.

Such a method thus makes it possible to identify a location of the payload storage space that has not been allocated or that has been released and therefore to detect an access error related to such a location.

According to embodiments, the method further comprises a step of initializing a value stored in a location of the payload storage space, the initialization of the stored value comprising storing a state indicator in a location of the error code storage space corresponding to the location of the payload storage space of which the value is initialized, the state indicator stored in a location of the error code storage space corresponding to the location of the payload storage space of which the value is initialized being representative of an initialization of a value of the payload storage space.

Such a method thus makes it possible to identify a location of the payload storage space that has been allocated and of which content has been initialized.

According to embodiments, the state indicator stored in a location of the error code storage space corresponding to the location of the payload storage space of which the value is initialized comprises a plurality of elements, each element of the plurality being representative of an initialization state of a coded value in a portion of the location of the payload storage space of which the value is initialized.

Such a method can thus be adapted to various data coding lengths in a location of the payload storage space.

According to another aspect, a non-transitory computer-readable media or computer program is proposed comprising instructions for executing each of the steps of the method described above. The advantages provided by this computer program are similar to those mentioned above.

Still according to another aspect, a memory controller is proposed for an embedded system provided with at least one memory unit comprising at least one payload storage space and a corresponding space for storing error detector codes or error corrector codes, called error codes. According to embodiments, the memory controller comprises a state indicator management module, the state indicator management module being configured to store a state indicator in a location of the error code storage space, the stored state indicator being independent of a payload stored in a corresponding location of the payload storage space and being representative of a state of the location of the payload storage space, and detect a memory access error in a location of the payload storage space depending on a state indicator stored in a corresponding location of the error code storage space.

Such a memory controller makes it possible to facilitate the development of embedded software by simplifying the detection of memory access errors, without substantial modification of the embedded system or additional specific resources and without using an advanced operating system.

According to yet another aspect, an embedded system is proposed comprising a memory controller as described above. The advantages provided by this embedded system are similar to those mentioned above.

According to embodiments, the embedded system further comprises an error management module for detecting and/or correcting data read errors, the embedded system further comprising a selection module for selecting the state indicator management module in a development mode and selecting the error management module in an operating mode.

### BRIEF DESCRIPTION OF THE DRAWINGS

Other advantages and features will become apparent upon examining the detailed description of non-limiting embodiments and implementations, and from the appended drawings, wherein:

FIG. 1 illustrates a portion of an embedded system;

FIG. 2 illustrates a flow chart for controlling an access to at least one portion of a memory unit, in a software development mode in an embedded system;

FIG. 3 illustrates a memory unit of an embedded system; and

FIGS. 4 and 5 illustrate coding a value of a state indicator, representative of a state of a location of a memory unit used to store payloads or instructions.

### DETAILED DESCRIPTION OF ILLUSTRATIVE EMBODIMENTS

According to embodiments, a status is associated with each location of at least one portion of a memory unit of an embedded system, during a phase for developing or testing a computer program or software. This status may particularly indicate if the location has been allocated and/or if the location has been initialized. It makes it possible to identify erroneous memory accesses, for example memory accesses at a location that has not been allocated or initialized. These locations may particularly be memory locations for data or instructions. They may or may not be allocated dynamically.

Still according to embodiments, the status is stored in a location of the memory of the embedded system that is used, when the software is executed in an operating mode, in order to store Error Correction Codes (ECC) or Error Detection Codes (EDC). Such codes, also called redundancy data, are generally stored on 7 bits for detecting and/or correcting errors in 32-bit words.

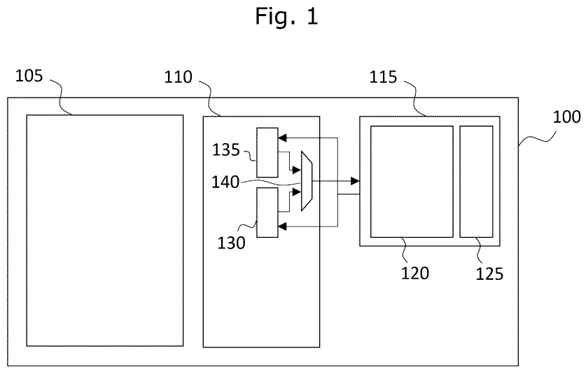

FIG. 1 schematically illustrates a portion of an embedded system 100. As illustrated, the embedded system 100 particularly comprises microprocessor 105, memory controller 110 (module or circuitry) and at least one non-transient memory unit or memory storage 115 itself comprising a first portion 120 for storing payloads or instructions, for example coded on 32 bits, and a second portion 125 for storing error correction codes or error detection codes, called error codes hereinafter, for example coded on 7 bits.

The memory controller 110 comprises here a standard redundancy management or error management module or circuitry 130 particularly having the object of computing an error code when writing data in the memory and of detecting and/or correcting an error when reading data. The memory controller 110 also comprises a state indicator management module or circuitry 135 for controlling the storage of a state indicator, accessing a previously stored state indicator and interpreting an accessed state indicator. According to the example illustrated, the memory controller 110 further comprises a selection module or circuitry 140 for selecting the standard redundancy management module 130 or the state indicator management module 135, for example depending on a usage mode of the embedded system.

In an operating mode, the selection module 140 selects the standard redundancy management module 130 to compute and store an error code when writing data in the memory and to detect and/or correct an error of data accessed in the memory. In a development mode, the selection module 140 selects the state indicator management module 135 to store, in a location of the second portion 125 of the memory unit 115, data characterizing a state of a corresponding location of the first portion 120 of the memory unit 115, to access such data characterizing a state and to detect an access anomaly at a location of the first portion 120 of the memory unit 115, for example if this location has not been allocated or has not been initialized.

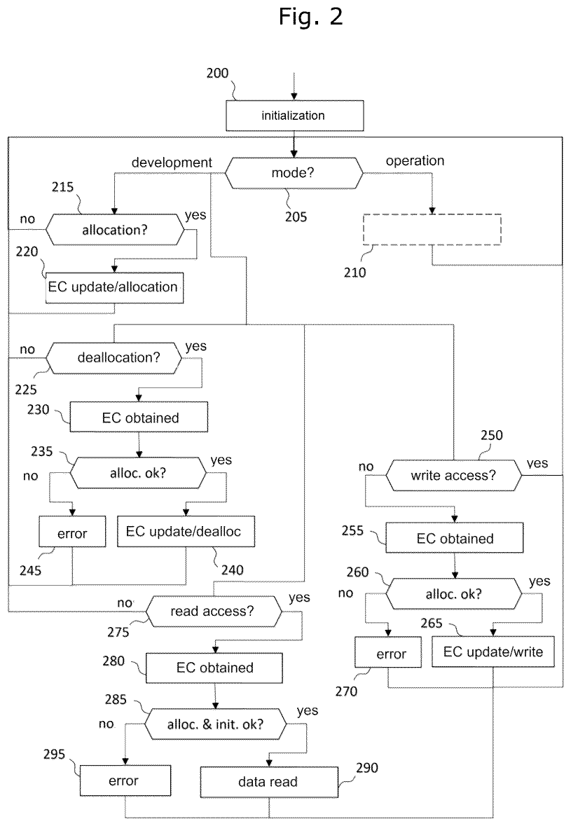

FIG. 2 illustrates an example of steps for controlling an access to at least one portion of a memory unit, in a software development mode in an embedded system such as that illustrated in FIG. 1.

According to this example, the object of a first step (step 200) is to initialize a second portion of a memory unit used to store data representative of a state of a first portion of a memory unit. According to embodiments, each location of the second portion of the memory unit is used to store data representative of a state, called state indicator, of a corresponding location of the first portion of the memory unit. The second portion of the memory unit is for example that used to store error codes in an operating mode of the embedded system. The first and second portions are for example the portions 120 and 125 of FIG. 1, respectively. The portion of the memory unit used to store data representative of a state of another portion of a memory unit is for example initialized with the value zero meaning that the corresponding locations of the other portion of the memory unit have not been allocated to an application.

The working mode of the embedded system is determined in a next step (step 205). This step may be implemented when launching an application, for example an application under development or a tested application, when launching a module of this application or when receiving a memory access command, directly or not, from this application. If the working mode is an operating mode, the memory is accessed in a standard manner (step 210). If, on the contrary, the working mode is a development or testing mode of an embedded software, the object of a next step is to determine the nature of a received command to be processed.

If the received command is a memory allocation command (step 215), for instructions or data, an amount of memory of a portion of a memory unit, for example the memory portion 120 in FIG. 1, defined according to the received command, is allocated (step 220), in a standard manner. Furthermore, during this step, a state indicator representing the state of each allocated location is stored in a location corresponding to the allocated location, for example in a memory location used, in operating mode, to store an error code, as described above. A state indicator representing an allocated state is for example coded on one bit, the value zero indicating a non-allocated location and the value one indicating an allocated location. Other values may be used. This may concern the fifth bit of the state indicator that corresponds to the error code normally stored in the memory used, in operating mode, to store an error code (b[4]=1 after allocation).

If the received command is a memory release command (step 225), also called memory deallocation, the address(es) of the memory locations to be deallocated are obtained. The address(es) obtained are then used to retrieve the state indicator(s) in the corresponding location(s) (step 230), for example in the memory portion 125 in FIG. 1.

A test is then carried out to determine whether the location(s) of the memory that must be deallocated have been previously allocated (step 235). According to embodiments, the value of the retrieved state indicators is used to determine whether the location(s) of the memory that must be deallocated have been previously allocated. According to the previous example, if the value of the fifth bit of the state indicator is equal to one, the corresponding location has been allocated and if it is equal to zero, it has not been allocated.

If the location(s) of the memory that must be deallocated have been previously allocated, an amount of memory of a portion of a memory unit, for example the memory portion 120 in FIG. 1, defined according to the received command, is deallocated (step 240), in a standard manner. Furthermore, during this step, the state indicator associated with each deallocated location, stored in a location corresponding to the deallocated location, for example in a memory location used, in operating mode, to store an error code, is modified to represent the new state (non-allocated). As described above, data representative of a non-allocated state (location not yet allocated or previously allocated, but released) is for example coded on one bit, the value zero indicating a non-allocated location and the value one indicating an allocated location. Once again, other values may be used and this may concern the fifth bit of the state indicator that corresponds to the error code normally stored in the memory used, in operating mode, to store an error code (b[4]=0 after deallocation.

On the contrary, if the location(s) of the memory that must be deallocated have not been previously allocated or have been deallocated since their last allocation (e.g. if the value of the fifth bit of the state indicator is equal to zero), an error is detected (step 245). According to embodiments, an interrupt is generated to indicate the error. Still according to embodiments, an indication relative to the error is transmitted, for example to indicate an attempt to deallocate a non-allocated location.

If the received command is a memory access command to write one or more data (step 250) at one or more locations of a memory unit, for example the memory portion 120 in FIG. 1, the address(es) of these locations are obtained. The address(es) obtained are then used to retrieve the state indicator(s) in the corresponding location(s) (step 255), for example in the memory portion 125 in FIG. 1.

A test is then carried out to determine whether the location(s) of the memory in which one or more data must be written have been allocated (step 260). According to embodiments, the value of the retrieved state indicator(s) is used to determine whether the location(s) of the memory in which one or more data must be written have been allocated. According to the previous example, if the value of the fifth bit of the state indicator is equal to one, the corresponding location has been allocated and if it is equal to zero, it has not been allocated.

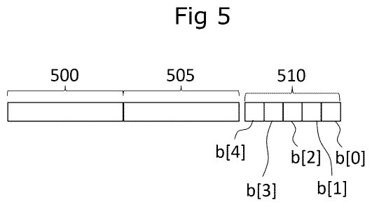

If the location(s) of the memory in which one or more data must be written have been allocated, the data are written (step 265). Furthermore, the value of the retrieved state indicator(s) is changed, in the location(s) corresponding to the location(s) in which the data are written, to indicate that data have been written and that, consequently, the value stored in this (these) location(s) has been initialized. As described with reference to FIG. 4, data representative of an initialized state is for example coded on 4 bits, each bit being associated with a byte, the value zero indicating a non-initialized location and the value one indicating an initialized location. This may concern the first four bits of the state indicator that corresponds to the error code normally stored in the memory used, in operating mode, to store an error code (b[0-3]=1 after initializing four bytes).

If the location(s) of the memory in which one or more data must be written have not been allocated (e.g. if the value of the fifth bit of the state indicator is equal to zero), an error is detected (step 270). According to embodiments, an interrupt is generated to indicate the error. Still according to embodiments, an indication relative to the error is transmitted, for example to indicate an attempt to write data at a non-allocated location.

If the received command is a memory access command to read one or more data (step 275) at one or more locations of a memory unit, for example the memory portion 120 in FIG. 1, the address(es) of these locations are obtained. The address(es) obtained are then used to retrieve the state indicator(s) in the corresponding location(s) (step 280), for example in the memory portion 125 in FIG. 1.

A test is then carried out to determine whether the location(s) of the memory in which one or more data must be read have been allocated and initialized (step 285). According to embodiments, the value of the retrieved state indicator(s) is used to determine whether the location(s) of the memory in which one or more data must be read have been allocated and initialized. According to the previous example and according to the size and the position of the data to be read, if the value of the first, second, third and/or fourth bits of the state indicator is equal to one, the corresponding location has been allocated and initialized.

If the location(s) of the memory in which one or more data must be read have been allocated and initialized, the data are read (step 290). On the contrary, if the location(s) of the memory in which one or more data must be read have not been allocated and initialized, an error is detected (step 295). According to embodiments, an interrupt is generated to indicate the error. Still according to embodiments, an indication relative to the error is transmitted, for example to indicate an attempt to read data at a non-initialized location.

According to the implementation of the selection module, the steps 220, 240, 245, 265, 270, 290 and 295 may loop towards the box 205 to take into account a possible mode change or towards the boxes 215, 225, 250 and 275 (i.e. the “development” output of the box 205) if it is not possible to envisage a mode change.

According to embodiments, the steps illustrated in FIG. 2 or some of these steps are implemented by a processor such as the microprocessor 105 illustrated in FIG. 1. Still according to embodiments, these steps or some of these steps are implemented by a separate processor in a specific testing environment. Still according to embodiments, some of these steps are implemented using a wired logic of the embedded system.

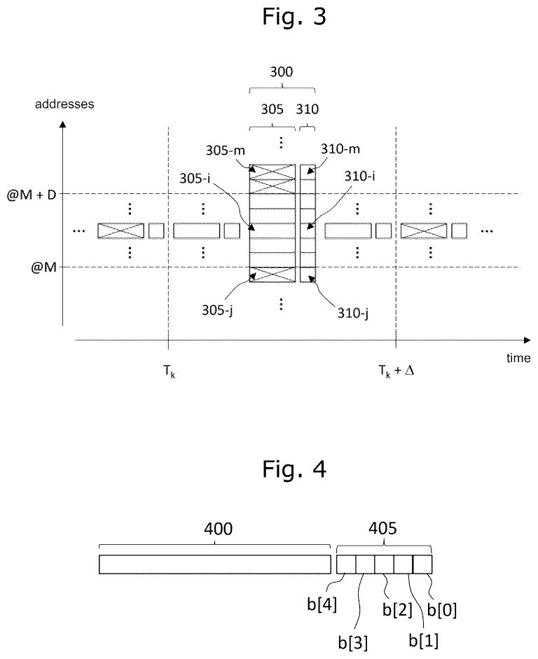

FIG. 3 schematically illustrates a memory unit 300 of an embedded system, comprising a first portion 305 configured to store payloads or instructions and a second portion 310 configured to store error correction codes or error detection codes (error codes). As illustrated, the content of the memory unit 300 varies over time. By way of illustration, the location 305-i contains valid data or a valid instruction between the times Tk and Tk+D, but does not contain valid data or a valid instruction before the time Tk (for example if the address has not been allocated or initialized) and after the time Tk+D (for example if the address has been released). Likewise, the content of the memory unit 300 varies in space. Still by way of illustration, the addresses M to M+D contain valid data or instructions between the times Tk and Tk+D, but the addresses preceding the address M and following the address M+D do not contain valid data or instructions.

In an operating mode, the software executed in the embedded system comprising the memory unit 300 uses the portion 305 to write and read payloads or instructions. Moreover, the embedded system comprises a redundancy mechanism, comprising error detection and correction modules, using the portion 310 to detect and/or correct the stored data or instructions that would be erroneous. Thus, when data or an instruction is stored in the portion 305 of the memory unit 300, for example at the address 305-i, the redundancy mechanism computes an error code that is stored in a corresponding location of the portion 310, here the location 310-i. When data or an instruction must be obtained from the portion 305 of the memory unit 300, for example at the address 305-i, the redundancy mechanism computes an error code from the data or the instruction stored at this location and compares it with the error code previously computed and stored in the location corresponding to the portion 310, here the location 310-i. If the error codes are identical, the data or the instruction obtained is transmitted to the software. In the opposite case, it is corrected before being transmitted or, if it cannot be corrected, an error signal is transmitted to the software.

In a development mode, the redundancy mechanism is deactivated to the benefit of a mechanism for controlling states of the memory unit, which uses the locations provided to store error codes in order to store state indicators of the corresponding locations in the memory used to store payloads or instructions, as described with reference to FIG. 2, in order to detect possible memory access errors. When data or an instruction must be written in the portion 305 of the memory unit 300 or read, for example at the address 305-i, the state control mechanism checks that the state of this location is compatible with the required operation. By way of illustration, it is considered here that the value of the state stored in the location 310-i indicates that the location 305-i has been allocated and initialized. Consequently, data may be read or written at this location. Still by way of illustration, it is considered here that the value of the state stored in the location 310-j indicates that the location 305-j has been allocated but has not been initialized. Consequently, data cannot be read at this location, but can be written. Also by way of illustration, it is considered that the value of the state stored in the location 310-m indicates that the location 305-m has not been allocated and, a fortiori, has not been initialized. Consequently, data can neither be read nor written at this location.

FIGS. 4 and 5 illustrate an example of coding a value of a state indicator, representative of a state of a location of a memory unit used to store payloads or instructions. According to the example illustrated, each location of a memory unit used to store payloads or instructions makes it possible to store a 32-bit word. Therefore, each location can be used to store a payload or an instruction of 32 bits, store two payloads or instructions of 16 bits, store four payloads or instructions of 8 bits, etc.

The state of a location is characterized here by 5 bits, one bit characterizing the allocated or not state of the location and four bits each characterizing the initialized or not state of each of the four bytes of the 32-bit word that can be stored at this location.

According to the example illustrated in FIG. 4, a location of a memory unit used to store payloads or instructions stores a 32-bit word 400. The corresponding location, in a portion of a memory unit normally used to store error codes, is used to store a state indicator, for example on 5 bits, each of the first 4 bits (b[0] to b[3]) corresponding to the indication according to which each of the 4 bytes of the 32-bit word has been initialized or not, respectively, and the fifth bit (b[4]) corresponding to the indication according to which the location of the 32-bits has been allocated or not.

According to this example, if a location has not been allocated, the state is 00000, if the location has been allocated but not initialized, the state is 10000 and if the location has been allocated and initialized, the state is 11111. Other codings can be used. By way of illustration, the bits b[1] to b[3] can be ignored or used for other purposes.

According to the example illustrated in FIG. 5, a location of a memory unit used to store payloads or instructions each stores two 16-bit words 500 and 505. Once again, the corresponding location, in a portion of a memory unit normally used to store error codes, is used to store a state indicator, here on 5 bits, each of the first 4 bits (b[0] to b[3]) corresponding to the indication according to which each of the 4 bytes of the 32-bit word has been initialized or not, respectively, and the fifth bit (b[4]) corresponding to the indication according to which the location of the 32-bits has been allocated or not.

According to this example, if a location has not been allocated, the state is 00000, if the location has been allocated but not initialized, the state is 10000, if the location has been allocated, but only one of the data or instructions is initialized, the state is 10011 or 11100 and if the location has been allocated and that the two data or instructions have been initialized, the state is 11111. Once again, other codings can be used. By way of illustration, the bits b[1] and b[3] can be ignored or used for other purposes.

In the same way, when a 32-bit word is used to store four data or instructions coded on 8 bits, each of the four bits of the state indicator can be used to indicate whether the value of the corresponding data or instruction has been initialized.

Here, it is observed that although, according to the previous examples, the locations of the memory unit make it possible to store 32-bit words, the method described above is not limited to this size.

What is claimed is:

1. A method for controlling memory access for an embedded computer program, during a development phase, the embedded computer program being executed in a device comprising at least one memory unit, the at least one memory unit comprising at least one payload storage space and a corresponding error code storage space, the method comprising:
storing a state indicator in a location of the error code storage space, the stored state indicator being independent of a payload stored in a corresponding location of the payload storage space and being representative of a state of the corresponding location of the payload storage space; and
detecting a memory access error in the corresponding location of the payload storage space based on the state indicator stored in the location of the error code storage space.

2. The method according to claim 1, further comprising initializing the error code storage space, the initializing comprising storing a respective state indicator in each location of the error code storage space, the respective state indicator stored in each location being representative of a misallocation of a corresponding respective location of the payload storage space.

3. The method according to claim 1, further comprising allocating, to the embedded computer program, at least one portion of the payload storage space, the allocating comprising storing a respective state indicator in each location of the error code storage space corresponding to the at least one portion of the payload storage space, the respective state indicator stored in each location of the error code storage space corresponding to the at least one portion of the payload storage space being representative of an allocation of a corresponding respective location of the payload storage space.

4. The method according to claim 1, further comprising deallocating at least one portion of the payload storage space, the deallocating comprising updating each state indicator in each location of the error code storage space corresponding to the at least one portion of the payload storage space to be deallocated, the state indicator updated in each location of the error code storage space corresponding to the at least one portion of the payload storage space to be deallocated being representative of a misallocation of a corresponding respective location of the payload storage space.

5. The method according to claim 1, further comprising initializing a value stored in the corresponding location of the payload storage space, the initializing the stored value comprising storing the state indicator in the location of the error code storage space corresponding to the location of the payload storage space of which the value is initialized, the state indicator stored in the location of the error code storage space corresponding to the location of the payload storage space of which the value is initialized being representative of an initialization of the value stored in the location of the payload storage space.

6. The method according to claim 5, wherein the state indicator stored in the location of the error code storage space corresponding to the location of the payload storage space of which the value is initialized comprises a plurality of elements, each element of the plurality of elements being representative of an initialization state of a coded value in a portion of the corresponding location of the payload storage space of which the value is initialized.

7. A non-transitory computer-readable media storing computer instructions for controlling memory access for an embedded computer program, executed in a device comprising at least one memory unit, the at least one memory unit comprising at least one payload storage space and a corresponding error code storage space, that, when executed by a processor during a development phase, cause the processor to:
store a state indicator in a location of the error code storage space, the stored state indicator being independent of a payload stored in a corresponding location of the payload storage space and being representative of a state of the corresponding location of the payload storage space; and
detect a memory access error in the corresponding location of the payload storage space based on the state indicator stored in the location of the error code storage space.

8. The non-transitory computer-readable media according to claim 7, further storing computer instructions that, when executed by the processor during the development phase, cause the processor to:
initialize the error code storage space, further comprising storing a respective state indicator in each location of the error code storage space, the respective state indicator stored in each location being representative of a misallocation of a corresponding respective location of the payload storage space.

9. The non-transitory computer-readable media according to claim 7, further storing computer instructions that, when executed by the processor during the development phase, cause the processor to:
allocate, to the embedded computer program, at least one portion of the payload storage space, further comprising storing a respective state indicator in each location of the error code storage space corresponding to the at least one portion of the payload storage space, the respective state indicator stored in each location of the error code storage space corresponding to the at least one portion of the payload storage space being representative of an allocation of a corresponding respective location of the payload storage space.

10. The non-transitory computer-readable media according to claim 7, further storing computer instructions that, when executed by the processor during the development phase, cause the processor to:
deallocate at least one portion of the payload storage space, further comprising updating each state indicator in each location of the error code storage space corresponding to the at least one portion of the payload storage space to be deallocated, the state indicator updated in each location of the error code storage space corresponding to the at least one portion of the payload storage space to be deallocated being representative of a misallocation of a corresponding respective location of the payload storage space.

11. The non-transitory computer-readable media according to claim 7, further storing computer instructions that, when executed by the processor during the development phase, cause the processor to:
initialize a value stored in the corresponding location of the payload storage space, further comprising storing the state indicator in the location of the error code storage space corresponding to the location of the payload storage space of which the value is initialized, the state indicator stored in the location of the error code storage space corresponding to the location of the payload storage space of which the value is initialized being representative of an initialization of the value stored in the location of the payload storage space.

12. A memory controller for controlling memory access for an embedded computer program in an embedded system having at least one memory unit comprising at least one payload storage space and a corresponding error code storage space, the memory controller comprising a state indicator management module, the state indicator management module configured to:
store a state indicator in a location of the error code storage space, the stored state indicator being independent of a payload stored in a corresponding location of the payload storage space and being representative of a state of the corresponding location of the payload storage space; and
detect a memory access error in the corresponding location of the payload storage space based on the state indicator stored in the location of the error code storage space.

13. The memory controller according to claim 12, wherein the state indicator management module is configured to initialize the error code storage space, further comprising the state indicator management module being configured to store a respective state indicator in each location of the error code storage space, the respective state indicator stored in each location being representative of a misallocation of a corresponding respective location of the payload storage space.

14. The memory controller according to claim 12, wherein the state indicator management module is configured to allocate, to the embedded computer program, at least one portion of the payload storage space, further comprising the state indicator management module being configured to store a respective state indicator in each location of the error code storage space corresponding to the at least one portion of the payload storage space, the respective state indicator stored in each location of the error code storage space corresponding to the at least one portion of the payload storage space being representative of an allocation of a corresponding respective location of the payload storage space.

15. The memory controller according to claim 12, wherein the state indicator management module is configured to deallocate at least one portion of the payload storage space, further comprising the state indicator management module being configured to update each state indicator in each location of the error code storage space corresponding to the at least one portion of the payload storage space to be deallocated, the state indicator updated in each location of the error code storage space corresponding to the at least one portion of the payload storage space to be deallocated being representative of a misallocation of a corresponding respective location of the payload storage space.

16. The memory controller according to claim 12, wherein the state indicator management module is configured to initialize a value stored in the corresponding location of the payload storage space, further comprising the state indicator management module being configured to store the state indicator in the location of the error code storage space corresponding to the location of the payload storage space of which the value is initialized, the state indicator stored in the location of the error code storage space corresponding to the location of the payload storage space of which the value is initialized being representative of an initialization of the value stored in the location of the payload storage space.

17. The memory controller according to claim 16, wherein the state indicator stored in the location of the error code storage space corresponding to the location of the payload storage space of which the value is initialized comprises a plurality of elements, each element of the plurality of elements being representative of an initialization state of a coded value in a portion of the corresponding location of the payload storage space of which the value is initialized.

18. An embedded system comprising:
at least one memory unit comprising at least one payload storage space and a corresponding error code storage space; and
a memory controller communicatively coupled to the at least one memory unit and comprising a state indicator management module, wherein the state indicator management module is configured to:
store a state indicator in a location of the error code storage space, the stored state indicator being independent of a payload stored in a corresponding location of the payload storage space and being representative of a state of the corresponding location of the payload storage space; and
detect a memory access error in the corresponding location of the payload storage space based on the state indicator stored in the location of the error code storage space.

19. The embedded system according to claim 18, wherein the memory controller further comprises:
an error management module configured to detect and/or correct data read errors; and
a selection module configured to select the state indicator management module in a development mode and select the error management module in an operating mode.

20. The embedded system according to claim 19, further comprising a microprocessor communicatively coupled to the memory controller.
